(19) United States
(12) Patent Application Publication
(10) Pub. No.: US 2012/0121993 A1
(43) Pub. Date: May 17, 2012

(54) Electrolyte containing methoxybenzene for use in lithium-air semi-fuel cells

(76) Inventors: David Chua, Wayne, PA (US); Owen Crowther, Philadelphia, PA (US); Benjamin Meyer, Lansdale, PA (US); Mark Salomon, Little Silver, NJ (US)

(21) Appl. No.: 12/927,340

(22) Filed: Nov. 12, 2010

(51) Int. Cl. H01M 12/06; H01M 10/056

(52) U.S. Cl. 429/405; 429/498

(57) ABSTRACT

Disclosed herein are electrolyte formulations containing methoxybenzene (also known as anisole or phenoxymethane) for use in lithium-air semi-fuel cells. Lithium-air semi-fuel cells contain a metallic lithium anode and an air (oxygen) fuel cell type porous carbon cathode. The reaction product in the cathode is lithium oxide (Li₂O) and/or lithium peroxide (Li₂O₂). This reaction product is sparingly soluble in common lithium-air cell solvents, and therefore the cathode pores become blocked over time, leading to cell end-of-life. Methoxybenzene is an organic solvent that demonstrates an increased solubility of Li₂O, which minimizes the clogging of the cathode. Lithium-air semi-fuel cells with electrolytes containing methoxybenzene demonstrate higher discharge capacities per the same weight, than the cells having electrolytes without methoxybenzene. Higher energy density semi-fuel cells are thus achieved.

### BACKGROUND OF THE INVENTION

1. Field of the Invention

This invention pertains to lithium-air semi-fuel cells which are composed of a metallic lithium (Li) anode and an air (oxygen) fuel cell type cathode. The air electrode is an interface where oxygen (O₂) from air is dissolved in an electrolyte solution and catalytically reduced on the active components of a porous cathode, normally carbon with or without a catalyst to enhance the rate of O₂ reduction. The products of this O₂ reduction involve insoluble lithium oxide (Li₂O) and lithium peroxide (Li₂O₂), if an organic aprotic solvent or ionic liquid is used in the electrolyte. Instant invention provides electrolyte, which helps to dissolve these oxides and thus improves the semi-fuel cell capacity and energy density.

2. Description of the Prior Art

Lithium-air semi-fuel cell usually comprise a flat lithium foil anode with a metal terminal tab attached, a flat porous carbon cathode with another metal terminal tab, and a porous electrically insulating separator between. All components are in contact with aprotic liquid electrolyte and sealed in a moisture-proof enclosure, with an opening at the cathode side for air entry. The opening may be sealed with a removable tape prior to use.

The overall cell reactions in organic electrolyte solutions are:

2Li+0.5O₂→Li₂O

2Li+O₂→Li₂O₂

An aprotic solvent is often used in Li-air semi-fuel cells because the solubility and diffusibility of gaseous oxygen is very large (e.g. see the publications by Read and Kowalczk et al.). However, both Li₂O and Li₂O₂ demonstrate minimal solubility in most aprotic electrolyte solutions, and both oxides will precipitate in pores of the carbon based cathode which blocks further O₂ intake and thus abruptly ends cell life. Initial reports suggested that the primary discharge product was Li₂O₂ (see the publication by Abraham and Jiang). However, most recent literature has suggested that Li₂O is the major product (see publications by Abraham et al., Lu et al., and Xu and Shelton). Increasing the Li₂O and/or Li₂O₂ solubility in the electrolyte increases the discharge capacity of lithium-air semi-fuel cells using an organic electrolyte (see publication by Xu et al.). This is because more of the discharge product is dissolved leading to a longer time before the carbon pores become blocked leading to cell failure. Therefore, it is desirable to provide an electrolyte, which increases the solubility of these oxides. Instant invention provides such electrolyte, and solution for more efficient utilization of available lithium, which results in higher energy density of the cells.

### SUMMARY OF THE INVENTION

It has now been found that substantially longer operational time is achieved by using methoxybenzene (also known as anisole phenoxymethane) as a solvent in electrolyte formulations of a lithium-air semi-fuel cell. Methoxybenzene is an organic compound with the formula CH₃OC₆H₅ (CAS 100-66-3).

This invention can be applied to any type of lithium-air semi-fuel cell. For example, this invention applies to cells in which the metallic lithium anode is protected by a glass-ceramic membrane, such as described in U.S. Patent of Visco U.S. Pat. No. 7,282,295, and US Patent Application of Kowalczyk et al. Ser. No. 11/586,327. In this type of cell, the cathode compartment may contain aprotic organic liquids or gels or ionic liquids that contains methoxybenzene and an electrolyte. The invention also applies to lithium-air semi-fuel cells where metallic lithium is separated from the cathode by a porous inert micro-porous membrane or a nonwoven fabric separator (Bondex polyester or cellulose for example) containing an aprotic electrolyte solution and where oxygen is selectively transported into the cathode through another membrane which blocks the transmission of water, such as described in U.S. patent application of Chua et al. Ser. No. 12/657,481.

Table one shows the solubility of Li₂O and Li₂O₂ in common lithium-air semi-fuel cell electrolyte solvents and methoxybenzene. The solubility of Li₂O is at least four times higher in methoxybenzene than propylene carbonate (PC) and dimethyl carbonate (DMC). Lithium-air semi-fuel cells with methoxybenzene in the electrolyte solution demonstrate higher discharge capacities than similar cells using electrolyte solutions which do not contain methoxybenzene.

Solubility/M

| | Li₂O | Li₂O₂ |
|---|---|---|
| PC | 0.013 | 0.000 |
| DMC | 0.000 | 0.026 |
| Anisole | 0.054 | 0.000 |

It has also been found, that the electrolyte solutions containing methoxybenzene are stable over the voltage range of interest for lithium-air semi-fuel cell.

The principal object of this invention is to provide higher energy density of lithium-air semi-fuel cells over prior art cells, due to better utilization of lithium and minimizing clogging of carbon cathode structure by the reaction by-products.

Another object of this invention is to provide a safer semi-fuel cell.

Other objects and advantages of the invention will be apparent from the description and claims.

### BRIEF DESCRIPTION OF THE DRAWINGS

The nature and characteristic features of the invention will be more readily understood from the following description taken in connection with accompanying drawings, in which:

FIG. 1 represents chemical symbol of methoxybenzene molecule.

FIG. 2 is showing cyclic voltammogram (CV) of electrolytes with and without methoxybenzene.

FIG. 3 is showing discharge voltage profile of lithium-air semi-fuel cells, using electrolyte solutions with and without methoxybenzene, without the presence of oxygen.

FIG. 4 is showing discharge capacities of 10 cm² pouch type lithium-air semi-fuel cells, using electrolyte solutions with and without methoxybenzene, as a function of current density.

FIG. 5 is showing voltage profile for 100 cm² lithium-air semi-fuel cells, using electrolytes with and without methoxybenzene.

It should, of course, be understood that the description and the drawings herein are merely illustrative, and it will be apparent that various modifications and changes can be made without departing from the spirit of the invention and from the scope of the appended claims.

### DETAILED DESCRIPTION OF THE PREFERRED EMBODIMENTS

When referring to the preferred embodiments, certain terminology will be utilized for the sake of clarity. Use of such terminology is intended to encompass not only the described embodiment, but also all technical equivalents which operate and function in substantially the same way to bring about the same results.

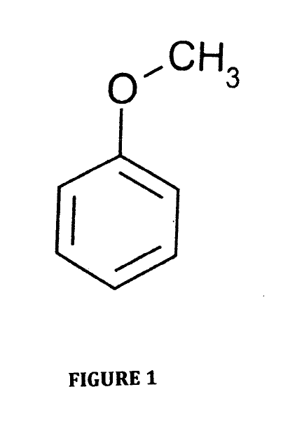

Lithium-air semi-fuel cell usually comprises lithium-metal anode foil or sheet, electrically insulating porous separator, and porous carbon cathode sheet or plate, all saturated with ion conductive, nonaqueous electrolyte, and enclosed in a housing having an opening(s) for air access to the cathode. The lithium anode may be also protected by a sealed around glass-ceramic, ion-conductive sheet with a non-aqueous electrolyte between the ceramic and the anode, such as described by Visco in U.S. Pat. No. 7,282,295 and by Kowalczyk et al. in U.S. patent application Ser. No. 11/586,327, and the whole cell maybe protected by oxygen selective, water and water vapor blocking, permeable membranes or gels, as described by Chua et al. in U.S. patent application Ser. No. 12/657,481, which are incorporated herein by reference. The instant invention pertains to a new technology developed to extend the operational time and safety of lithium-air semi-fuel cells, which utilize electrolyte solutions based on aprotic solvents. This technology, as described below, also increases the energy density of the cells, due to increased efficiency. This invention includes the use of methoxybenzene, which molecule is shown in FIG. 1, in the electrolyte solution in any type of lithium-air semi-fuel cell. The electrolyte solution could use methoxybenzene as the only solvent, or could include methoxybenzene with a mixture of other aprotic organic liquid solvents, such as propylene carbonate, gamma-butyrolactone, ethylene carbonate, methylethyl carbonate, dimethyl carbonate, dimethoxy ethane, and their mixtures; and/or ionic liquid solvents, such as 1-butyl-1-methyl pyrrolidinium imide, 1-ethyl-3-methylimidazolium bisperfluoroethylsulfonyl imide, 1-ethyl-3-methylimidazolium bisperfluoroethylsulfonyl imide and their mixtures.

The electrolyte solution can contain any compatible lithium salt, such as LiPF₆, LiN(SO₂C₂F₅)₃, LiSO₃CF₃, LIClO₄, LiI, LiSCN, lithium tetraphenylborate, and their mixtures at concentrations that provide sufficient ionic conductivity, 0.1-2 mol dm-3. The electrolyte solution may also contain other additives, such as tris(pentaflurophenyl)borane, boron esters, and their mixtures, to further increase the solubility of Li₂O and Li₂O₂. Furthermore, the electrolyte solution may be “gelled” using polymers, such as polyvinylidene fluoride (PVDF), polyacrylonitrile (PAN), ethymethyl methacryate, and their alloys.

There is no limitation on the type or air cathode which can be used in this invention. Commercial air cathodes from ETEK or Electric Fuel Ltd. can be used as well as custom designated air cathodes based on carbons well known to practitioners in the art of fabricating and manufacturing fuel cell and lithium-air cell cathodes. Carbons such as Super P, Vulcan XC-72, Black Pearls 2000 and Ketjen Blacks 300 and 600 are preferred examples.

### EXAMPLES

The following examples provide details of lithium-air semi-fuel cell performance at room temperature, based on the concepts of this invention. These examples are provided to clearly illustrate the principles of this invention and are not intended to be limiting.

### Example 1

### Stability of Methoxybenzene Over Voltages of Interest in Primary Lithium-Air Semi-Fuel Cells

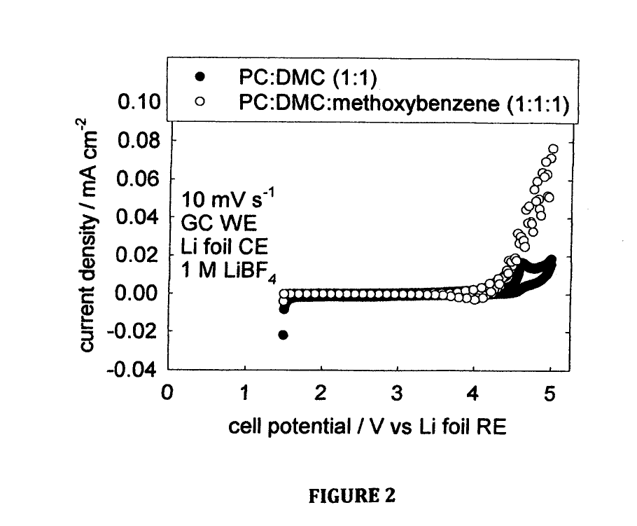

FIG. 2, which is one embodiment of the invention, shows the cyclic voltammetry of electrolyte solutions with and without methoxybenzene. Cyclic voltammetry is an electrochemical experimental technique where the voltage is varied linearly with time, here at a rate of 0.01 V s⁻¹. The CV is obtained by plotting the resulting current density on the vertical axis and the corresponding potential on the horizontal axis. In this experiment, the working electrode is glassy carbon with an area of 1 cm², the counter electrode is lithium foil pressed onto nickel ribbon, and the reference electrode is also lithium foil pressed onto nickel ribbon. The CVs for the electrolytes containing methoxybenzene and without methoxybenzene both produce negligible current density over the voltage range of interest for a primary lithium-air semi-fuel cell (˜3.5 V-˜1.5 V vs. Li RE). Since PC and DMC are known to be stable components of primary lithium-air semi-fuel cells (see publications by Xu et al. and Crowther et al.), methoxybenzene is also stable over this voltage range.

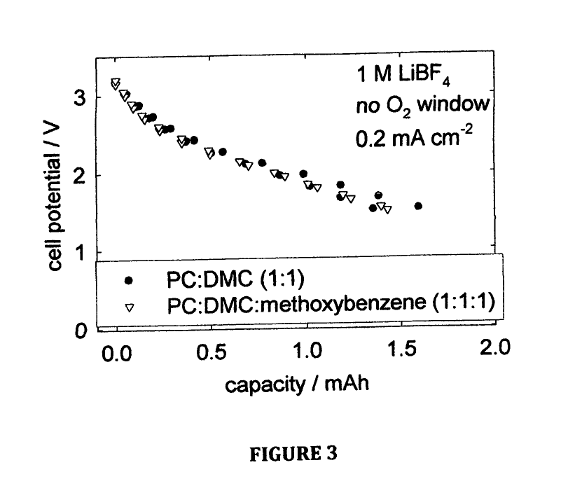

FIG. 3, which is another embodiment of the invention, further demonstrates that methoxybenzene is stable for use in primary lithium-air semi-fuel cell. Cells were constructed that consisted of a lithium anode and a porous, carbon based cathode separated by a 40.6 μm thick sheet of porous cellulose. The cathode consisted of approximately 80% KetJen Black EC600G carbon and 20% Teflon. The thickness of the cathode was approximately 0.014 cm and the exposed outer surface area was 10 cm₂. Two cells were discharged with an electrolyte solution containing methoxbenzene and two cells were discharged with an electrolyte solution that did not have methoxybenzene. The discharge rate for these cells was 0.2 mAcm⁻². However, the O₂ window for all four of these cells was blocked so only residual O₂ in the electrolyte solution could be reduced during discharge. Any additional capacity demonstrated by the cells with electrolyte solution containing methoxybenzene would be caused by the reduction of methoxybenzene. All four cells had similar capacities, demonstrating again that methoxybenzene is stable over the voltages interest.

### Example 2

### High Discharge Capacities Demonstrated by Lithium-Air Semi-Fuel Cells Using Electrolyte Solutions with Methoxybenzene

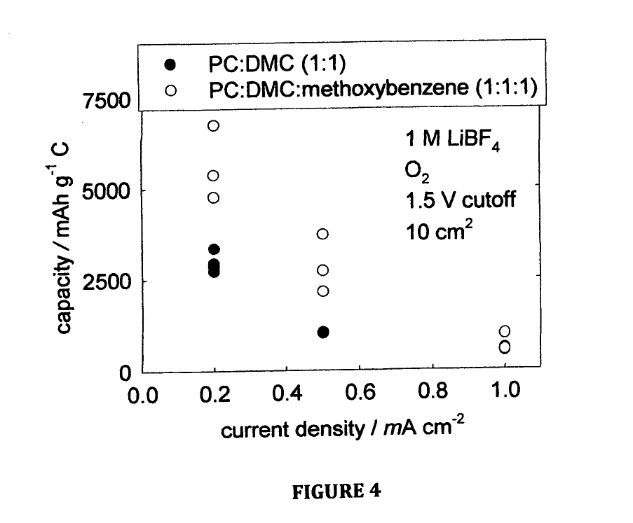

FIG. 4, which is another embodiment of the invention, shows the discharge capacities of lithium-air semi-fuel cells in O₂ as a function of current density. These cells were built in the same manner as described above in the discussion of FIG. 3, except O₂ was permitted to enter these cells. These cells were discharged in a heat sealed pouch containing approximately 7 cm³ of electrolyte solution. The pouch contained a 10 cm² porous Teflon window pressed onto the side of the cathode facing the atmosphere that permitted O₂ into the pouch, while preventing liquid electrolyte solution from leaking out of the cell into the atmosphere. The entire pouch was placed in a bag filled with O₂ at 1 atm. These cells exhibited extremely high discharge capacities: 4767 to 6741 mAh g⁻¹ C at 0.2 mAcm⁻², 2130 to 3710 mAh g⁻¹ C at 0.5 mAcm⁻², and 421 to 753 mAh g⁻¹ C at 1 mA cm².

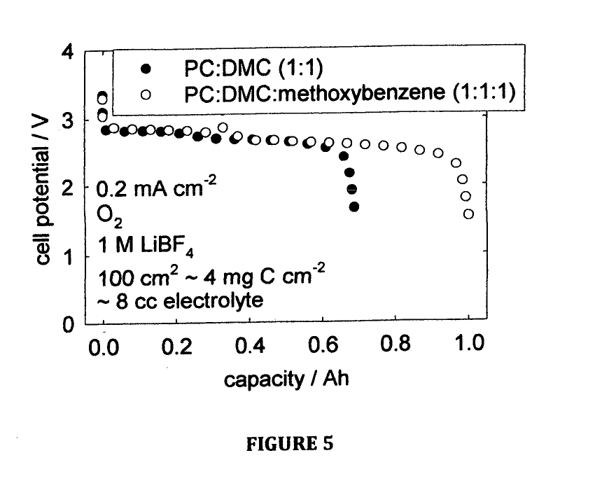

FIG. 5, which is another embodiment of the invention, shows the voltage profile during discharge at 0.2 mA cm⁻² of a fixture lithium-air semi-fuel cell. This cell contains a 100 cm² lithium anode, a 40.6 μm cellulose separator, and a 100 cm² cathode. The cathode is the same as the ones described above except for its 100 cm² surface area. This cell was filled with 8 cm³ of electrolyte solution containing methoxybenzene. The discharge capacity of these larger cells was over 1 Ah. This demonstrates that lithium-air semi-fuel cells using methoxybenzene are scalable.

### COMPARATIVE EXAMPLES

Lithium-air semi-fuel cells using electrolytes without methoxybenzene also discharged in O₂ are also shown in FIGS. 4 and 5, which is another embodiment of the invention as proof. Details are given in the Comparative Examples below.

### Comparative Examples 1

### Lithium-Air Semi-Fuel Cells Using Electrolyte Solutions not Containing Methoxybenzene

Lithium-air semi-fuel cells were built in the same manner as those described in FIGS. 4 and 5 above. However, instead of using electrolyte solution of 1 M LiBF₄ in PC:DMC:methoxybenzene (1:1:1 by volume), the methoxybenzene was removed and an electrolyte containing 1 M LiBF₄ in PC:DM (1:1 by volume) was used. These discharge capacities are significantly higher for all the cells using an electrolyte solution containing methoxybenzene. In FIG. 4, discharge capacity increases by a factor of 2 to 3. In FIG. 5, the addition of methoxybenzene increases the discharge capacity 31%.

The invention disclosed herein includes the use of methoxybenzene in all types of electrolyte solutions used in lithium-air semi-fuel cells. The major feature of these electrolyte solutions, besides high ionic conductivity is a high Li₂O solubility, which leads to an increased discharge capacity. There are many alternate ways of implementing processes for significantly reducing clogging of the air electrode, and the present invention is not limited to the details described.

All references cited herein are incorporated by reference for all purposes. It should of course be understood, that the description and the drawings herein are merely illustrative and it will be apparent, that various modifications and combinations can be made of the structures and the systems disclosed without departing from the spirit of the invention.

We claim:

1. A lithium-air semi-fuel cell having a metallic lithium anode, a porous carbon cathode, and a porous separator between said anode and cathode, and an electrolyte in contact with said anode, separator and cathode, which electrolyte contains methoxybenzene.

2. A lithium-air semi fuel cell as described in claim 1, in which said electrolyte contains only methoxybenzene as solvent.

3. A lithium-air semi-fuel cell as described in claim 1, in which said electrolyte contains a mixture of methoxybenzene solvent with other solvents.

4. A lithium-air semi-fuel cell as described in claim 1, in which said lithium metal anode is protected by a glass-ceramic membrane.

5. A lithium-air semi-fuel cell as described in claim 1, which cell is protected by oxygen selective, water and water vapor blocking, permeable membrane, over said cathode.

6. A non-aqueous electrolyte for lithium-air semi-fuel cells, which contains methoxybenzene.

7. A non-aqueous electrolyte as described in claim 6, which additionally contains a mixture of other aprotic solvents.

8. A non-aqueous electrolyte as described in claim 6, in which said electrolyte contains salts selected from the group comprising: LiBF₆; LiBF₄, LiN(SO₂E₂F₅)₃, LiSO₃CF₃; LiCEO₄; LiI; LiSCN; lithium tetraphenylborate; and their mixtures.

9. A non-aqueous electrolyte as described in claim 7, in which said other solvents are selected from the group comprising: propylene carbonate, gamma-butyrolactone, ethylene carbonate, methylethyl carbonate, dimethyl carbonate, dimethoxy ethane, and their mixtures.

10. A non-aqueous electrolyte as described in claim 7, in which said other solvents are ionic liquids selected from the group comprising: 1-butyl-1-methyl pyrrolinium imide, 1-ethyl-3-methylimidazolium, bisperfluoroethylsulfonyl imides, and their mixtures.

11. A non-aqueous electrolyte as described in claim 6, which additionally contains additives for increasing solubility of Li2O and Li₂O₂, selected from the group comprising: tris(pentaflurophenyl)borane, boron esters, and their mixtures.

12. A non-aqueous electrolyte as described in claim 6, which is used as a plasticizer in gelled polymers, selected from the group comprising: PVDF, ethyl methyl methacrylate, polyacrylonitrile, and their alloys.
